(19) United States
(12) Patent Application Publication
(10) Pub. No.: US 2019/0213268 A1
(43) Pub. Date: Jul. 11, 2019

(54) DYNAMIC SUBTREE PINNING IN STORAGE SYSTEMS

(71) Applicant: Red Hat, Inc., Raleigh, NC (US)

(72) Inventors: Patrick Joseph Donnelly, Sacramento, CA (US); John Charles Spray, Farnborough (GB); Gregory Allan Farnum, Los Angeles, CA (US); Douglas James Fuller, Nashville, TN (US); Zheng Yan, Shanghai (CN); Ramana Krisna Venkatesh Raja, Bengaluru (IN)

(21) Appl. No.: 15/867,174

(22) Filed: Jan. 10, 2018

(51) Int. Cl. G06F 17/30

(52) U.S. Cl. CPC G06F 17/30203; G06F 17/30168; G06F 17/30327

(57) ABSTRACT

A subtree pinning system includes a file system tree, a plurality of metadata servers, and a metadata server assignment system. The file system tree includes a plurality of subtrees. The metadata servers are configured to manage the plurality of subtrees. The metadata server assignment system is configured to receive a command to reassign a subtree to a first metadata server. The metadata server assignment system is also configured to remove an assignment of a second metadata server to manage the subtree and create an assignment of the first metadata server to manage the subtree. The metadata server assignment is further configured to prevent the subtree from being managed by another metadata server.

### BACKGROUND

Many distributed file systems allow file systems to be divided into a hierarchy of subtrees that can be managed by multiple metadata servers (MDSs). The metadata servers handle changes to the metadata of the subtrees and handle client requests to change the subtrees. These requests may include creating new directories in the file system, changing metadata for existing files or directories, or moving files between directories. MDS loads may be automatically balanced by splitting and merging subtrees and altering MDS assignments.

### SUMMARY

The present disclosure presents new and innovative systems and methods for pinning subtrees in storage systems. In an example, a system includes a file system tree including a plurality of subtrees. Additionally, the system includes a plurality of metadata servers configured to manage the plurality of subtrees. The system further includes a metadata server assignment system configured to receive a command to reassign a subtree to a first metadata server. The metadata server assignment system is further configured to remove an assignment of a second metadata server to manage the subtree and create an assignment of the first metadata server to manage the subtree. The metadata server assignment system is further configured to prevent the subtree from being managed by another metadata server.

In another example, a method includes receiving a command to reassign a subtree of a file system tree to a first metadata server. The method further includes removing an assignment of a second metadata server to manage the subtree and creating an assignment of the first metadata server to manage the subtree. The method also includes preventing the subtree from being managed by another metadata server.

In a further example, a computer readable medium stores instructions which, when executed by one or more processors, cause the one or more processors to receive, at a manual subtree pinning system, a command to reassign a subtree of a file system tree to a first metadata server. The instructions also cause the one or more processors to remove an assignment of the second metadata server to manage the subtree and create an assignment of the first metadata server to manage the subtree. Further, the instructions cause the one or more processors to prevent the subtree from being managed by another metadata server.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a block diagram of an example computing system according to an example embodiment of the present disclosure.

FIG. 2 illustrates an example file system tree according to an example embodiment of the present disclosure.

FIG. 3 illustrates a flowchart of an example method according to an example embodiment of the present disclosure.

FIG. 4 illustrates a flowchart of an example method according to an example embodiment of the present disclosure.

FIG. 5 illustrates a flow diagram of an example method according to an example embodiment of the present disclosure.

FIG. 6 illustrates a block diagram of an example system according to an example embodiment of the present disclosure.

### DETAILED DESCRIPTION OF EXAMPLE EMBODIMENTS

Techniques are disclosed for pinning subtrees in a filing system. Distributed file systems, such as the CephFS from Red Hat® and the Red Hat® Cluster Suite may include dynamic load balancers that manage the assignment of subtrees to an MDS. However, these automated systems may fail when presented with certain degenerate workloads and the file system may operate better if particular MDS assignments for subtrees are made. For example, a client may be performing read operations spread across more than one MDS on subtrees that could be consolidated to a single MDS to improve file system performance. Similarly, the file system may receive many read requests from multiple clients, but each client is only accessing a single subtree. System performance may improve if each subtree were assigned to an MDS close to the client accessing it. Further, multiple clients performing create operations in different parts of the file system may confuse the dynamic load balancer, which may not properly balance the load and impede performance. In this case, system performance may improve if subtrees were assigned to particular MDSs in order to properly balance the load. There is currently no way to make these assignments without disrupting the operation of the dynamic load balancers in the rest of the file system.

As described in the examples below, one method to address these problems is to pin file system subtrees in a way that does not disrupt the automatic load balancing system. This method may prevent a pinned subtree and its children from being reassigned by a dynamic load balancer while permitting other unpinned subtrees to be reassigned by the dynamic load balancer.

One way to accomplish this is for the user to initiate a request to pin a subtree to a particular MDS. The subtree pinning system may then remove the subtree's currently-assigned MDS and assign the subtree to the desired MDS, pinning the subtree to that MDS. The system may then prevent the pinned subtree and its children from being reassigned by the dynamic load balancer until the user unpins the subtree. The system may also unpin the subtree automatically after a set period of time.

If a child of the pinned subtree is separately pinned to a different MDS, the system may also prevent the child from being automatically reassigned by the dynamic load balancer. Further, if the parent is unpinned, the system may continue preventing the child from being automatically reassigned even though the dynamic load balancer is now permitted to pin the parent subtree. Thus, this arrangement enables the benefits of a system that pins subtrees to MDSs (i.e., the ability to respond to degenerate workflows) as needed in the file system tree, while preserving the benefits of dynamic load balancers (i.e., automatic management and response to changing workloads) for the rest of the file system tree.

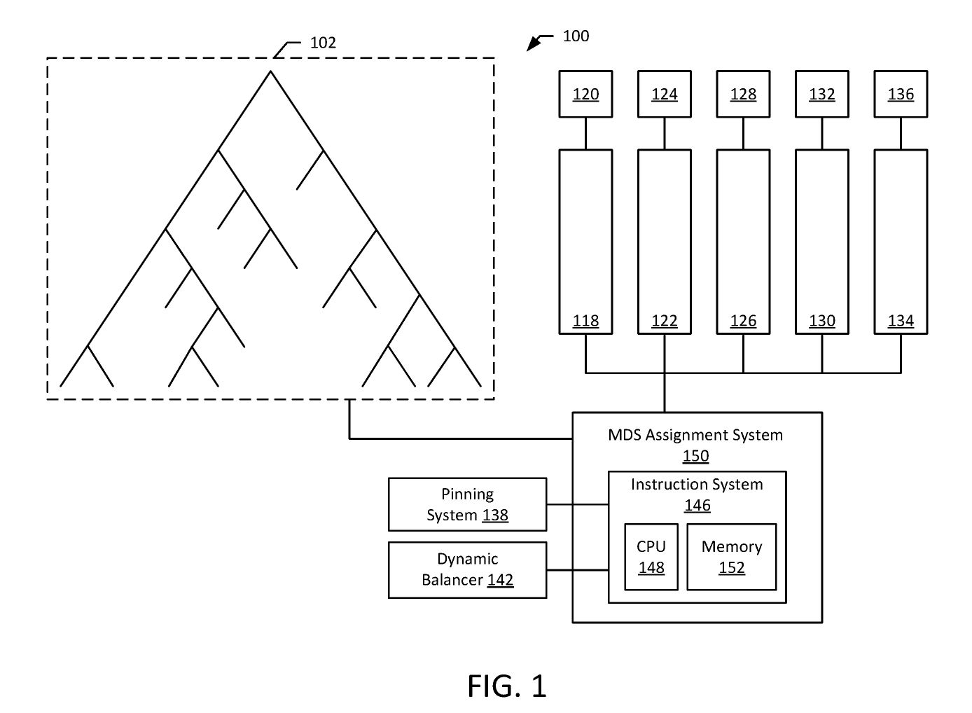

FIG. 1 depicts a block diagram of an example computing system 100 according to an example embodiment of the present disclosure. The computing system 100 includes a file system tree 102. The system 100 also includes MDSs 118, 122, 126, 130, 134 and MDS attributes 120, 124, 128, 132, 136. The system further includes an MDS assignment system 150 containing an instruction system 146 which itself contains a CPU 148 and a memory 152. The instruction system is connected to a pinning system 138 and a dynamic balancer 142.

The file system tree 102 may be implemented as a distributed file system spread across one or more computing devices. The file system tree 102 need not be expressly set up as a tree data structure. Rather, it may also be set up as an analogous structure, such as a folder hierarchy or other hierarchical data structure. Similarly, as discussed throughout this disclosure, any reference to a file system tree (or “tree”) contemplates any hierarchical data structure and any reference to a file system subtree (or “subtree”) contemplates any piece or portion of a hierarchical data structure.

The file system tree 102 may be attached to the metadata servers (MDSs) 118, 122, 126, 130, 134. The MDSs 118, 122, 126, 130, 134 may be assigned to monitor the metadata for one or more subtrees within the file system tree 102. One or more of the MDSs 118, 122, 126, 130, 134 may also remain unassigned, operating in a standby mode to balance the load of the file system as necessary. For example, the MDS 134 may operate in a standby mode. The MDSs 118, 122, 126, 130, 134 may be located in a single location, or may be distributed geographically. For example, the MDSs 118, 122, and 126 may be located in New York and the MDSs 130 and 134 may be located in California. Such an arrangement may be advantageous because it distributes the workload geographically and may enable MDS reassignment to reduce the distance between a client and the MDS it accesses. Alternatively, the MDSs 118, 122, 126, 130, 134 may be located on one or more server racks that also include client devices that interact with the file system tree 102. This type of arrangement may be advantageous because the close proximity enables faster interactions between the MDSs 118, 122, 126, 130, 134 and the client devices. The MDSs 118, 122, 126, 130, 134 may be selected to minimize the distance from the client device. The MDSs may be implemented by computer hardware or by software, including virtual machines, user processes, and containers in a virtual machine system. More than one MDS 118, 122, 126, 130, 134 may run on the same computer hardware in separate VMs or containers, or may run within the same operating system, virtual machine, or container as separate user processes.

The MDSs may include the MDS attributes 120, 124, 128, 132, 136. The MDS attributes 120, 124, 128, 132, 136 may indicate the subtrees that an MDS manages and may record whether the assignment of a particular subtree was automatic or whether the subtree was pinned. The MDS attributes 120, 124, 128, 132, 136 may be implemented as metadata for the MDSs 118, 122, 126, 130, 134; as an entry in an MDS assignment database; or as subtree metadata corresponding to assigned subtrees.

The file system tree 102 and the MDSs 118, 122, 126, 130, 134 are connected to an MDS assignment system 150. The MDS assignment system 150 may be configured to reassign subtrees to the MDSs 118, 122, 126, 130, 134 based on commands received from the pinning system 138 and the dynamic balancer 142. The MDS assignment system 150 may be configured to receive commands to assign subtrees to MDSs and determine whether the subtree to be reassigned has been pinned. If the subtree has been pinned, the MDS assignment system 150 may ignore or refuse the command if it came from the dynamic balancer 142. If the subtree has not been pinned, the MDS assignment system 150 may perform the command if the command came from the dynamic balancer 142. If the command came from the pinning system 138, the MDS assignment system 150 may perform the requested subtree reassignment regardless of whether the subtree was pinned and may not perform the determination of whether the subtree to be assigned was pinned.

The MDS assignment system 150 further includes an instruction system 146. The instruction system may be configured to receive commands from the pinning system 138 and the dynamic balancer 142. The instruction system 146 may implement one or more of the configurations discussed above regarding the MDS assignment system 150, including the subtree reassignment and pinning operations. In particular, the instruction system 146 may determine whether an automatically-generated command from the dynamic system 142 is attempting to reassign a subtree that was pinned or whose parent was pinned by the pinning system 138. The instruction system 146 further includes a CPU 148 and a memory 152. The memory 152 may include instructions that, when executed by the CPU 148, perform the operations of the instruction system 146 and/or the MDS assignment system 150.

Although depicted as a separate module, the MDS assignment system 150 may also be implemented in software. In such an example, the MDS assignment system 150 may run in a virtual machine, as a user process, or in a container separated from or connected to the MDSs 118, 122, 126, 130, 134. In this implementation, the instruction system 146 may also be implemented similarly in software and the CPU 148 and the memory 152 may be virtualized or may not be contained in the instruction system 146. Software-based implementations of these components may enable faster scaling and better file system performance.

The instruction system 146 is connected to the pinning system 138 and the dynamic balancer 142. The dynamic balancer 142 may be configured to automatically generate commands that balance the workload distributed between the MDSs 118, 122, 126, 130, 134. For example, the dynamic balancer 142 may determine that the MDS 118 has a high workload and the MDS 130 has a low workload. The dynamic balancer 142 may automatically generate a command to reassign one or more of the subtrees managed by the MDS 118 to be managed by the MDS 130. The dynamic balancer 142 may also uniformly distribute workloads by striping subtrees across the MDSs 118, 122, 126, 130, 134 such that the workloads are even. The dynamic balancer 142 may be implemented as a software utility that runs within the file system 102 itself, or a software utility that runs outside of the file system 102.

The pinning system 138 may be configured to generate commands that reassign a subtree to be managed by a different MDS and prevent the dynamic balancer 142 from further reassigning the subtree. The pinning system 138 may generate commands based on a request from a user, such as a system administrator or file system client. The user may interact with a user interface to create the request, or may run one or more lines of code that create the request. For example, the user may use a GUI to indicate that a subtree should be pinned to a particular MDS, or may type a line of code indicating the same in a command line. The user may also include a line of code within a separate program that causes the pinning system 138 to create a request.

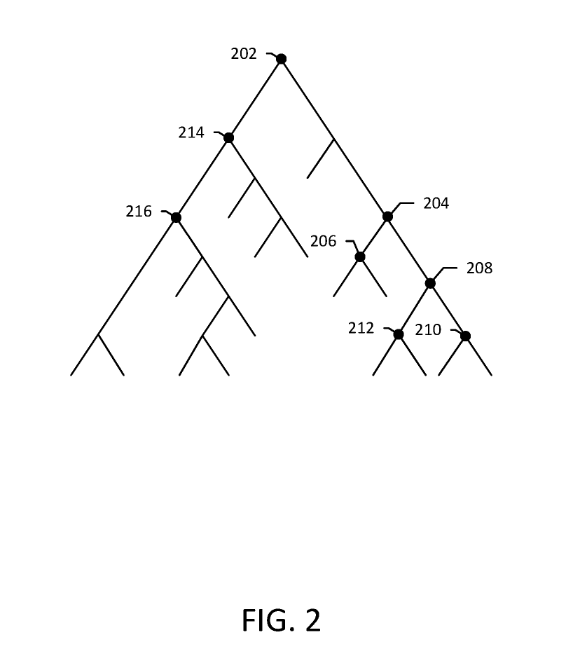

FIG. 2 depicts an example file system tree 202 according to an example embodiment of the present disclosure. Trees and subtrees within this disclosure will be denoted by the highest node of the tree included in the tree or subtree. For example, the file system tree 202 includes all of the nodes within the tree. As another example, the subtree 204 includes the nodes 206, 208, 210, and 212. The subtrees can be contained within other subtrees. For example the subtree 216 is contained within the subtree 214 and the subtrees 206 and 208 are contained within the subtree 204.

Although file system tree 202 only includes a maximum of 2 child nodes per parent node, this was only intended for clarity of illustration. File system trees and other hierarchical databases including more than 2 children per parent are contemplated. Also, as used throughout this disclosure, the terms “parent” and “parent subtree” may refer to any subtree defined by a node located above the child subtree, and need not be the subtree defined by the node directly above the child subtree. For example, the subtree 204 is a parent of the subtree 212 even though the subtree 208 is also a parent of the subtree 212. In certain examples, the terms “grandparent” and “grandparent subtree” may be used to simplify the discussion. For example, the subtree 208 may be referred to as a parent of the subtree 212 and the subtree 204 may be referred to as a grandchild of the subtree 212. Similarly, the terms “child” or “child subtree” need not refer to the subtree defined by the node immediately below a parent. For example, the subtree 212 is a child of the subtree 204. Further, the terms “grandchild” and “grandchild subtree” may be used to simplify the discussion. For example, the subtree 212 is a child of the subtree 208 and a grandchild of the subtree 204.

The file system tree 102 may be implemented by the file system tree 202. For example, the pinning system 138 may generate a command to assign subtree 216 to MDS 118. The dynamic system 142 may then automatically generate a command to assign subtree 214 to MDS 122. After processing this request, the MDS assignment system 150 would assign the subtree 214 to the MDS 122, but the subtree 216 would stay pinned to the MDS 118. If the dynamic system 142 later automatically generated a command to reassign subtree 216 to the MDS 120, the reassignment would not be completed because the subtree 216 is pinned to the MDS 118. Similarly, if the subtree 204 is pinned to the MDS 130 and the dynamic system 142 automatically generates a command to reassign the subtree 208 to the MDS 126, the reassignment would not be completed because the subtree 208's parent, the subtree 204 is pinned. Likewise, if the subtree 204 is pinned to the MDS 130 and the dynamic system 142 automatically generates a command to reassign the subtree 210 to the MDS 122, the reassignment would not be completed because the subtree 210's grandparent, the subtree 204 is pinned.

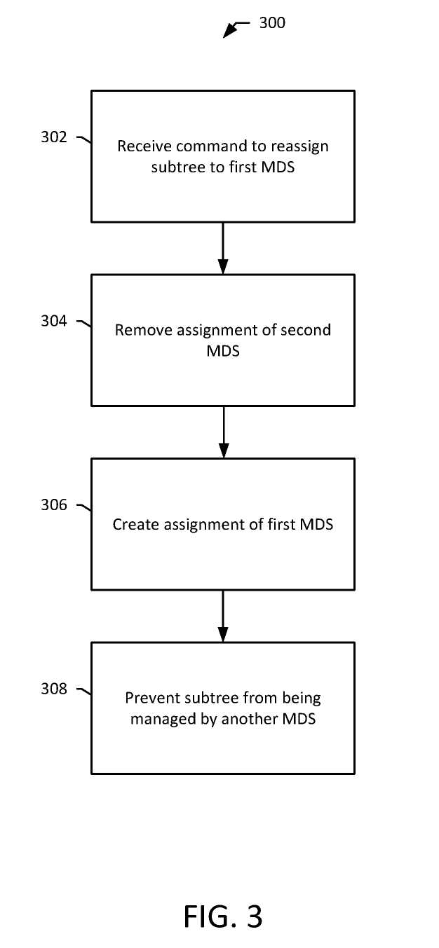

FIG. 3 depicts a flowchart of an example method 300 according to an example embodiment of the present disclosure. The method 300, when executed, may be used to pin a subtree to a particular MDS. The method 300 may be implemented on a computer system, such as the system 100. For example, method 300 may be implemented by the MDS assignment system 150 and/or the instruction system 146. The method 300 may also be implemented by a set of instructions stored on a computer readable medium that, when executed by a processor, cause the computer system to perform the method. For example, all or part of the method 300 may be implemented by the CPU 148 and the memory 152. Although the examples below are described with reference to the flowchart illustrated in FIG. 3, many other methods of performing the acts associated with FIG. 3 may be used. For example, the order of some of the blocks may be changed, certain blocks may be combined with other blocks, one or more of the blocks may be repeated, and some of the blocks described may be optional. Also, although discussed in the context of an individual command, the method 300 may include processing multiple requests in parallel when implemented. For example, two or more requests may be received simultaneously and the method 300 may include processing them together by proceeding through the steps in parallel.

The method 300 may begin by receiving a command to reassign a subtree to a first MDS (block 302). For example, instruction system 146 may receive a command generated by the pinning system 138. The command may have been generated by a user request, such as a user request created by a user interface, a line of code executed in a command line, or a line of code included within a program running within a file system, such as the file systems 102 or 202. The command may include an indication of the subtree that is to be pinned and the MDS to which it is to be pinned. For example, the command may indicate that the subtree 204 is to be pinned to the MDS 134. The MDS may be selected by a user for reasons including balancing the workload distribution between the MDSs, overriding a confused or malfunctioning dynamic balancer, moving a workflow to an MDS located closer to a user or a user's computing device, preparing for an increased workload, or clustering one or more otherwise-scattered subtrees needed by a user onto the same MDS.

The method 300 next proceeds with removing the assignment of the subtree to the second MDS (block 304). The assignment may be removed by altering an MDS attribute, such as the MDS attributes 120, 124, 128, 132, 136. For example, if the MDS assignment system 150 received a command to reassign the subtree 204 to the MDS 134 when the subtree 204 is initially assigned to the MDS 122, the MDS assignment system 150 may remove from the MDS attribute 124 an indication that the MDS 122 manages the subtree 204. Alternatively, removing the assignment may be implemented by altering an entry in an MDS assignment database. For example, this may be accomplished by deleting an entry from the MDS assignment database indicating that the MDS 122 manages the subtree 204. In some examples, the MDS assignment database may be implemented within the MDS assignment system 150. In a third example, removing the assignment may be implemented by altering subtree metadata (e.g., a POSIX extended file attribute in a Unix® system) that corresponds to the assigned subtree. In the previous example, this may be implemented by altering the subtree 204's metadata to remove the indication that the subtree 204 is managed by the MDS 122. In some examples, the subtree 204's metadata is stored as metadata for the node 204. Thus, in such examples, it is possible for the subtree 208 to have separate metadata stored as metadata for the node 208.

The method 300 also includes creating an assignment of the first MDS (block 306). The assignment may be created by altering an MDS attribute, such as any one of the MDS attributes 120, 124, 128, 132, 136. For example, if the MDS assignment system received a command to reassign the subtree 204 to MDS 134, it may add an indication that the MDS 134 manages the subtree 204 to the MDS attribute 136. Alternatively, creating the assignment may be implemented by altering an entry in an MDS assignment database. In the preceding example, this may be accomplished by adding an entry to an MDS assignment database indicating that the MDS 134 manages the subtree 204. In some examples, the MDS assignment database may be implemented within the MDS assignment system 150. In a third example, creating the assignment may be implemented by altering the subtree metadata that corresponds to the assigned subtree. In the previous example, this may be implemented by altering the subtree 204's metadata to include an indication that the subtree 204 is managed by the MDS 134.

The method 300 next proceeds with preventing the subtree from being managed by another MDS (block 308). The prevention may be implemented by one or both of the MDS assignment system 150 or the instruction system 146. These systems may be configured to detect when a subtree has been pinned and may ignore requests by the dynamic balancer 142 to reassign a pinned subtree. For example, after pinning the subtree 204 to the MDS 134, the instruction system 146 may receive an automatically-generated command from the dynamic balancer 142 to reassign the subtree 204 to the MDS 126. The instruction system 146 may be configured to detect that the subtree 204 has been pinned to the MDS 134 and thus refuse to act on the dynamic balancer 142's automatically-generated command. Other examples may include assigning a priority rating to commands generated by the pinning system 138 that is greater than the priority rating assigned to commands generated by the dynamic balancer 142. The instruction system 146 may be configured to ignore requests to reassign a subtree that have a priority lower than the request to pin the subtree had. The subtree may be prevented from being reassigned until another command is received to unpin the subtree, or it may be prevented from being reassigned for a set period of time. For example, the pinning system 138 may be required to generate an unpinning command before subtree 204 can be reassigned from MDS 134. In another example, subtree 204 may be pinned to MDS 134 for a set period of time (e.g., 1 hour, 12 hours, 1 day, 2 days, or 1 week), after which commands automatically generated by the dynamic balancer 142 may cause the instruction system 146 to reassign the subtree 204 to a different MDS.

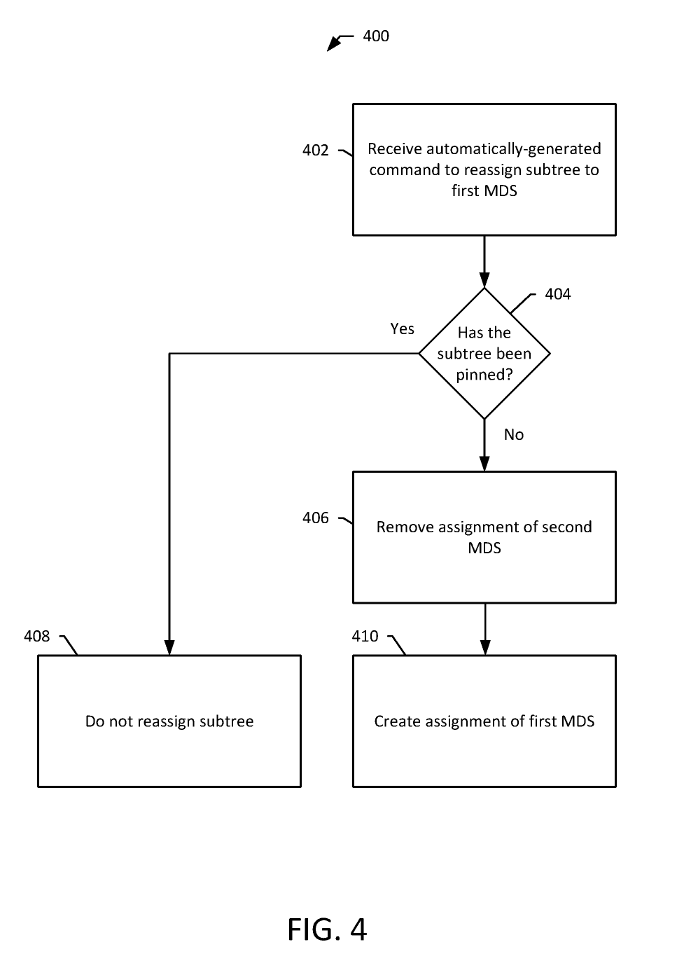

FIG. 4 depicts a flowchart of an example method 400 according to an example embodiment of the present disclosure. The method 400, when executed, may be used to automatically reassign subtrees to MDSs in order to balance workloads or improve system performance. The method 400 may be implemented on a computer system, such as the system 100. For example, method 400 may be implemented by the MDS assignment system 150 and/or the instruction system 146. The method 400 may also be implemented by a set of instructions stored on a computer readable medium that, when executed by a processor, cause the computer system to perform the method. For example, all or part of the method 400 may be implemented by the CPU 148 and the memory 152. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional. Also, although discussed in the context of an individual command, the method 400 may process multiple requests in parallel when implemented. For example, two or more requests may be received simultaneously and method 400 may process them together by proceeding through the steps in parallel.

The method 400 may begin by receiving an automatically-generated command to reassign a subtree to a first MDS (block 402). For example, instruction system 146 may receive a command generated by the dynamic balancer 142. The command may have been generated by the dynamic balancer 142 to balance workloads between the MDSs 118, 122, 126, 130, 134 or to improve performance of the system.

The method 400 proceeds with determining whether the subtree has been pinned (block 404). It may be determined that a subtree was pinned if the subtree itself was pinned or if the subtree's parent was pinned. For example, if the received command was to reassign subtree 208, the MDS assignment system 150 or instruction system 146 may determine that the subtree 208 is pinned if the subtree 208 itself was pinned or if the subtree 204 was pinned. The determination may be implemented by evaluating the MDS attribute 120, 124, 128, 132, 136 for the subtree's current MDS. This evaluation may be performed by the instruction system 146 of the MDS assignment system 150. For example, the instruction system 146 may receive an automatically-generated command to reassign the subtree 216 to the MDS 126 when the subtree 216 is initially assigned to the MDS 118. The instruction system 146 may evaluate MDS attribute 120 corresponding to the MDS 118 for an indication of the assignment of the subtree 216 to the MDS 118. If the indication reflects that the subtree 216 or its parent was pinned, it may be determined that the subtree 216 was pinned. Alternatively, determining whether the subtree has been pinned may be implemented by evaluating an entry in an MDS assignment database. In the previous example, this may be accomplished by the instruction system 146 evaluating the entry in the MDS assignment database indicating that the MDS 118 manages the subtree 216. If the entry indicates that the subtree 216 or its parent was pinned, the instruction system 146 may determine that subtree 216 was pinned. In some examples, the MDS assignment database may be implemented within the MDS assignment system 150. In a third example, determining whether the subtree has been pinned may be implemented by evaluating subtree metadata that corresponds to the assigned subtree or its parent. In the previous example, this may be implemented by the instruction system 146 evaluating the subtree 216's metadata to examine the indication that it is managed by the MDS 118. This may also be implemented by the instruction system 146 performing a search, such as a nearest neighbor search, of the subtree 216's parents to determine whether any of the subtree 216's parents' metadata include an indication that any of the subtree 216's parents were pinned. If either the subtree 216 or one of its parent subtrees has metadata indicating that it was pinned, the instruction system 146 may determine that the subtree 216 was pinned.

If it is determined that the subtree was pinned, then the subtree is not reassigned (block 408). By not reassigning the subtree, the method 400 preserves the pinning operation discussed elsewhere in this disclosure, such as in regards to FIG. 3. In some examples, the MDS assignment system 150 or instruction system 146 may inquire into secondary considerations before deciding not to reassign the subtree. For example, the pinning operation may be performed for a set period of time, such as 1 hours, 12 hours, 1 day, 2 days, or 1 week. In such an example, the MDS assignment system 150 or instruction system 146 may further determine whether the automatically-generated command was received at the block 402 after the period of time had expired. In such cases, processing may proceed to the blocks 406 and 410 as discussed below. Another example may include assigning priorities to different requests based on the originating system and whether it was user-created. In such an example, the MDS assignment system 150 or instruction system 146 may further determine whether the automatically-generated command received at the block 402 had a priority greater than the request to pin the subtree. In such cases, processing may proceed to the blocks 406 and 410 as discussed below.

If it is determined at the block 404 that the subtree was not pinned, then the method 400 proceeds with removing the assignment of the second MDS (block 406) and creating an assignment of the first MDS (block 410). Each of these processes may be performed in ways similar to the operations discussed regarding the blocks 304 and 306 of the method 300, respectively. For example, if the MDS assignment system 150 received a command to reassign the subtree 216 to the MDS 122 when the subtree 216 is initially assigned to the MDS 126, the MDS assignment system 150 may remove from the MDS attribute 128 an indication that the MDS 126 manages the subtree 216 and add an indication that the MDS 122 manages the subtree 216 to the MDS attribute 124.

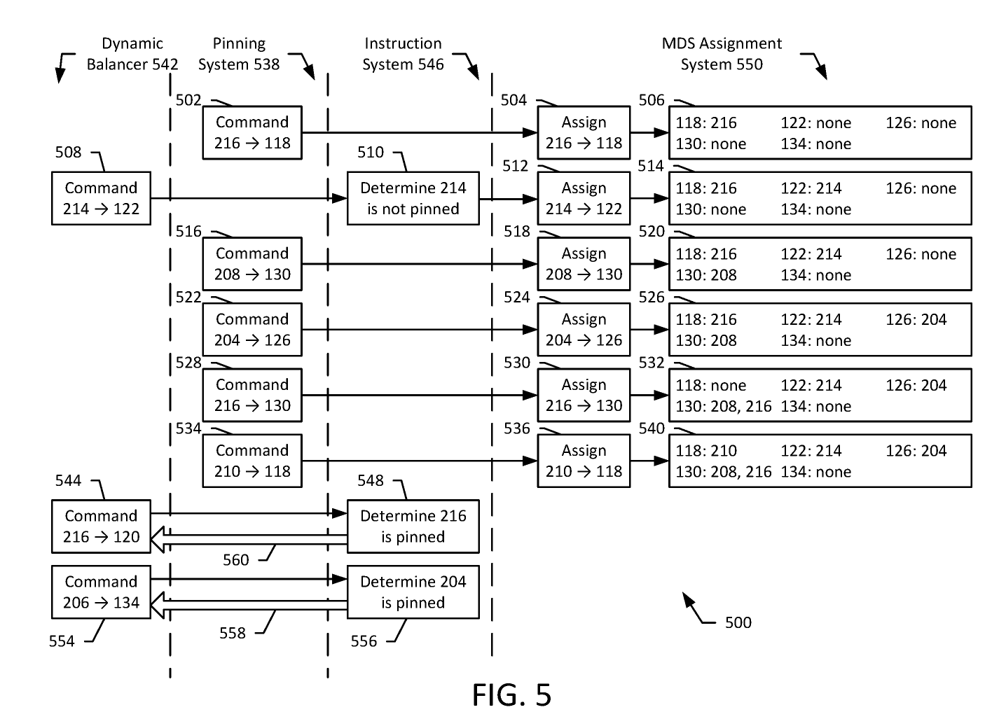

FIG. 5 depicts a flow diagram of an example method 500 according to an example embodiment of the present disclosure. The method 500 may be used to pin a subtree to a particular MDS without disrupting a dynamic balancer from automatically reassigning unpinned subtrees. The method 500 may be implemented on a computer system, such as the system 100. For example, the dynamic system 542 may be implemented by the dynamic balancer 142, the pinning system 538 may be implemented by the pinning system 138, the instruction system 546 may be implemented by the instruction system 146, and the MDS assignment system 550 may be implemented by the MDS assignment system 150. The method 500 may also be implemented all or in part by a set of instruction stored on a computer readable medium that, when executed by a processor, cause the computer system to perform the method. For example, all or part of the method 500 may be implemented by the CPU 148 and the memory 152. This method 500 is also discussed in the context of specific example commands and operations, but these examples are not limiting and analogous commands and operations, including subtree hierarchies that extend beyond child subtrees and grandchild subtrees are within the scope of the present disclosure.

The method 500 begins with the pinning system 538 generating a command 502 to assign the subtree 216 to the MDS 118. The pinning system 538 may generate commands, such as the command 502, at the request of a user, such as a system administrator, in order to manually balance workload or improve system performance. The method 500 next proceeds with the MDS assignment system 550 assigning the subtree 216 to the MDS 118 (block 504). Prior to executing this method, all of the subtrees were either unassigned or assigned to MDSs not relevant to this example. Accordingly, after the block 504, the subtree 216 is assigned to MDS 118 and the remaining MDSs 122, 126, 130, 134 are unassigned (block 506). In some examples, such unassigned MDSs may operate in standby mode or be powered down to reduce energy costs.

The method next proceeds with the dynamic balancer 542 generating a command 508 to assign the subtree 214 to MDS 122. The dynamic balancer may generate the command 508 to balance the file system workload among the MDSs, or to improve system performance. Because the command 508 was automatically generated by the dynamic balancer 542, processing proceeds to the instruction system 546 determining that the subtree 214 is not pinned (block 510). Thus, the MDS assignment system proceeds to assign the subtree 214 to the MDS 122 as the command 508 indicated (block 512). This operation leaves the subtree 216 assigned to the MDS 118 and the subtree 214 assigned to the MDS 122 (block 514). Notably, although the subtree 214 is a parent of the subtree 216, reassigning the subtree 214 did not change the subtree 216's assignment because the subtree 216 was pinned.

The method 500 next proceeds with the pinning system 538 generating a command 516 to the assign subtree 208 to the MDS 130. The MDS assignment system 550 next assigns the subtree 208 to the MDS 130 (block 518). This operation leaves the subtree 216 assigned to the MDS 118, the subtree 214 assigned to the MDS 122, and the subtree 208 assigned to the MDS 130 (block 520). Note that, in this example, commands from the pinning system 538 are not evaluated by the instruction system 546 to determine whether the assigned subtree is pinned, but commands from the dynamic balancer 542 are evaluated. In some examples, however, the method 500 may include steps to evaluate each command at the instruction system. For example, the instruction system may compare the priority of the requests to reassign for each user requesting to reassign the subtree. In such an example, the system may deny requests to pin a subtree that are from users or processes of a lower priority than the user or process that initially pinned the subtree.

The method 500 next proceeds with the pinning system 538 generating a command 522 to assign the subtree 204 to the MDS 126. The MDS assignment system next assigns the subtree 204 to the MDS 126 (block 524). This operation leaves the subtree 216 assigned to the MDS 118, the subtree 214 assigned to the MDS 122, the subtree 208 assigned to the MDS 130, and the subtree 204 assigned to the MDS 126 (block 526). Note that, although the subtree 204 is the subtree 208's parent, the request to pin the subtree 204 did not reassign the subtree 208. Instead, the subtree 208 remained pinned to MDS 130.

A command generated by the pinning system 538 may override a previous command generated by the pinning system 538. For example, the method 500 next proceeds with the pinning system 538 generating a command 528 to assign the subtree 216 to the MDS 130. The MDS assignment system 550 next assigns the subtree 216 to the MDS 130 (block 530). This operation leaves the subtrees 216 and 208 assigned to the MDS 130, the subtree 214 assigned to MS 122, and the subtree 204 assigned to the MDS 126 (block 532). Note that, although the subtree 216 was already pinned by the command 502, the instruction system 546 does not evaluate whether the subtree 216 was pinned because the command was generated by the pinning system 538. Other examples of this method, however, may evaluate commands generated by the pinning system 538 as discussed above in connection with the command 516.

The method next proceeds with the pinning system 538 generating command 534 to assign the subtree 210 to the MDS 118. The MDS system 550 next assigns the subtree 210 to the MDS (block 536). This operation leaves the subtrees 216 and 208 assigned to the MDS 130, the subtree 214 assigned to the MDS 122, the subtree 204 assigned to the MDS 126, and the subtree 210 assigned to the MDS 118 (block 540). Note that the subtree 210 is a child of the subtree 208 and a grandchild of the subtree 204. The command 534 to reassign the subtree 210 did not impact the assignment of either the parent subtree 208 or the grandparent subtree 204, and the fact that the subtrees 208 and 204 were pinned did not preclude pinning the subtree 210.

However, a previous command generated by the pinning system 538 may pin a subtree such that the commands generated by the dynamic balancer 542 to reassign a pinned subtree are rejected. For example, the method 500 next proceeds with the dynamic balancer 542 generating a command 544 to reassign the subtree 216 to the MDS 120. However, the instruction system 546 next determines that the subtree 216 is already pinned and rejects command 544 (block 548). This rejection may be implemented by refusing to perform the command's operation. It may also further be implemented by issuing a rejection record 560 back to the dynamic balancer explaining the reason why its operation was not performed. The rejection record 560 may be implemented as an alert, an email, a log entry, or a returned value and may include an indication of the reason for the rejection (e.g., which subtree was pinned and/or which MDS manages the pinned subtree).

Similarly, a previous command generated by the pinning system 538 may pin a parent subtree such that commands generated by the dynamic balancer 542 to reassign a child of the pinned parent subtree are rejected. For example, the method 500 next proceeds with the dynamic balancer 542 generating a command 554 to reassign the subtree 206 to the MDS 134. However, the instruction system 546 next determines that the subtree 204, a parent of subtree 206, is pinned (block 556). The instruction system 546 may determine this by performing a search, such as a nearest neighbor search, for the closest parent subtree with an MDS assignment. Alternatively, each subtree may have its own recorded MDS assignment that the instruction system 546 evaluates. Because the subtree 206's parent is pinned, the instruction system 546 rejects the command 554. This rejection is may include a rejection record 558 similar to rejection record 560 discussed above.

Note that, after the method 500 has completed, the MDS 134 remains free of any assigned subtrees. The MDS 134 may be operating in a standby mode, to be utilized as needed to balance out workloads and improve system performance. The MDS 134 may also be powered down or put into a reduced power mode of operation in order to reduce energy use and energy costs. Also, the MDS 130 has two subtrees, the subtrees 208 and 216, assigned to it. As discussed above, an MDS may be capable of managing more than one subtree.

Although the assignment operations discussed in connection with method 500 were all described as being performed by the MDS assignment system 550, other examples of the method perform the assignment operations using other components. For example, the assignment operations may be performed by instruction systems 546, 146.

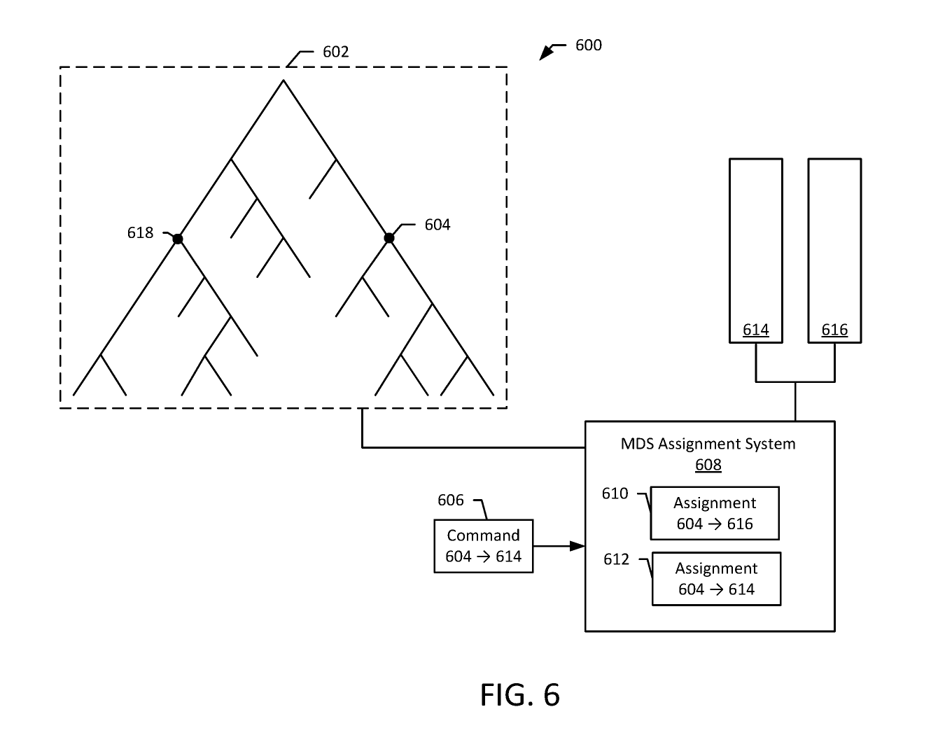

FIG. 6 depicts a block diagram of an example system 600 according to an example embodiment of the present disclosure. The system 600 includes a file system tree 602 including a plurality of subtrees 604, 618. The system 600 also includes a plurality of metadata servers 614, 616 configured to manage the plurality of subtrees 604, 618. The system 600 also includes a metadata server assignment system 608 configured to receive a command 606 to reassign a subtree 604 to a first metadata server 614. The metadata server assignment system 608 is also configured to remove an assignment 610 of a second metadata server 616 to manage the subtree 604 and create an assignment 612 of the first metadata server 614 to manage the subtree 604. The metadata server assignment system 608 is further configured to prevent the subtree 604 from being managed by another metadata server (e.g., metadata server 616).

As evidenced in the method 500 and in other examples discussed throughout the present disclosure, the present systems and methods enable the manual assignment of subtrees to particular MDSs without interfering with dynamic balancing operations. This system improves the performance of the file system by bypassing the dynamic balancers where the dynamic processes are ineffective while still allowing the dynamic balancers to operate where they are effective. Further, this system can prepare in advance for planned heavy or atypical workflows by pre-assigning subtrees to advantageous MDSs, while still maintaining the dynamic autonomy of the rest of the file system. Even where dynamic balancers could properly process such workflows, the dynamic balancers are reactive and thus cannot anticipate and pre-assign subtrees like the manual pinning system can. Accordingly, although it may require greater manual effort than a system that exclusively utilizes dynamic balancers, the systems and method discussed in the present disclosure improve system response times and load balancing.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A system comprising:
a file system tree including a plurality of subtrees;
a plurality of metadata servers configured to manage the plurality of subtrees;
a metadata server assignment system configured to:
receive a command to reassign a subtree to a first metadata server;
remove an assignment of a second metadata server to manage the subtree;
create an assignment of the first metadata server to manage the subtree; and
prevent the subtree from being managed by another metadata server.

2. The system of claim 1, wherein the metadata server assignment system is further configured to prevent the subtree from being managed by another metadata server over a period of time, which ends when a command to reassign the subtree is received.

3. The system of claim 1, wherein the metadata server assignment system is further configured to prevent the subtree from being managed by another metadata server for a set period of time.

4. The system of claim 1, further comprising:
a dynamic load balancer configured to automatically remove assignments of metadata servers with high loads to manage subtrees and create assignments of metadata servers with low loads to manage subtrees.

5. The system of claim 2, wherein the metadata server assignment system is further configured to override the dynamic load balancer and prevent the dynamic load balancer from removing the assignment of the first metadata server to manage the subtree.

6. The system of claim 1, wherein the metadata server assignment system is implemented by updating directory metadata corresponding to the subtree.

7. The system of claim 1, wherein the metadata server assignment system is further configured to prevent a child of the subtree from being pinned by another metadata server over a period of time, which ends when a command to reassign the child is received.

8. The system of claim 1, wherein:
the subtree includes a plurality of child subtrees; and
the metadata server assignment system is further configured to:
receive a subsequent command to reassign a child subtree to a third metadata server;
remove the assignment of the first metadata server to manage the child subtree;
create an assignment of the third metadata server to manage the child subtree; and
prevent the child subtree from being managed by another metadata server.

9. The system of claim 8, wherein:
the child subtree includes a plurality of grandchild subtrees; and
the metadata server assignment system is further configured to:
receive a second subsequent command to reassign a grandchild subtree to a fourth metadata server;
remove the assignment of the third metadata server to manage the grandchild subtree;
create an assignment of the third metadata server to manage the grandchild; and
prevent the grandchild subtree from being managed by another metadata server.

10. The system of claim 1, wherein the command to reassign the subtree to the first metadata server is received in response to a degenerate workflow, including one or more of workload imbalances, proximity of the metadata server to a user device, and specialized workflows.

11. A method comprising:
receiving a command to reassign a subtree of a file system tree to a first metadata server;
removing an assignment of a second metadata server to manage the subtree;
creating an assignment of the first metadata server to manage the subtree; and
preventing the subtree from being managed by another metadata server.

12. The method of claim 11, wherein preventing the subtree from being managed by another metadata server further comprises:
preventing the subtree from being managed by another metadata server over a period of time, which ends when a command to reassign the subtree is received.

13. The method of claim 11, wherein preventing the subtree from being managed by another metadata server further comprises:
preventing the subtree from being managed by another metadata server for a set period of time.

14. The method of claim 11, wherein preventing the subtree from being managed by another metadata server further comprises:
preventing a dynamic load balancer from removing the assignment of the first metadata server to manage the subtree, wherein the dynamic load balancer is configured to automatically remove assignments of metadata servers with high loads to manage subtrees and create assignments of metadata servers with low loads to manage subtrees.

15. The method of claim 11, wherein the method is performed by updating directory metadata corresponding to the subtree.

16. The method of claim 11, further comprising:
preventing a child of the subtree from being pinned by another metadata server over a period of time, which ends when a command to reassign the child is received.

17. The method of claim 11, further comprising:
receiving a subsequent command to reassign a child subtree of the subtree to a third metadata server;
removing the assignment of the first metadata server to manage the child subtree;
creating an assignment of the third metadata server to manage the child subtree; and
preventing the child subtree from being managed by another metadata server until another command is received.

18. The method of claim 17, further comprising:
receiving a second subsequent command to reassign a grandchild subtree of the child subtree to a fourth metadata server;
removing the assignment of the third metadata server to manage the grandchild subtree;
creating an assignment of the third metadata server to manage the grandchild subtree; and
preventing the grandchild subtree from being managed by another metadata server.

19. The method of claim 10, wherein the command to reassign the subtree to the first metadata server is received in response to a degenerate workflow, including one or more of workload imbalances, proximity of the metadata server to a user device, and specialized workflows.

20. A computer readable medium storing instructions which, when executed by one or more processors, cause the one or more processors to:
receive, at a metadata server assignment system, a command to reassign a subtree of a file system tree to a first metadata server;
remove an assignment of the second metadata server to manage the subtree;
create an assignment of the first metadata server to manage the subtree; and
prevent the subtree from being managed by another metadata server.
